(19) United States
(12) Patent Application Publication
(10) Pub. No.: US 2022/0159675 A1
(43) Pub. Date: May 19, 2022

(54) USER EQUIPMENT

(71) Applicant: NTT DOCOMO, INC., Tokyo (JP)

(72) Inventors: Shohei Yoshioka, Chiyoda-ku, Tokyo (JP); Satoshi Nagata, Chiyoda-ku, Tokyo (JP); Huan Wang, Beijing (CN); Xiaolin Hou, Beijing (CN)

(73) Assignee: NTT DOCOMO, INC., Tokyo (JP)

(21) Appl. No.: 17/438,764

(22) PCT Filed: Mar. 19, 2019
(86) PCT No.: PCT/JP2019/011509

§ 371 Date: Sep. 13, 2021

(51) Int. Cl. H04W 72/12; H04W 74/08

(52) U.S. Cl. CPC H04W 72/1263; H04W 92/18; H04W 74/0833

(57) ABSTRACT

Provided is a user equipment including: a transmitting unit configured to transmit a preamble to another user equipment; and a receiving unit configured to receive a response to the preamble from. the other user equipment.

### TECHNICAL FIELD

The present invention relates to a user equipment in a radio communication system.

### BACKGROUND ART

In the long term. evolution. (LTE) system and successor systems (for example, LTE advanced (LTE-A), and new radio (NR) (also referred to 5G)) of LTE, device-to-device (D2D) technologies, in which communication devices, such as user equipment, directly communicate with each other, instead of going through a base station gNB have been studied. (for example, Non-Patent Document 1).

In addition, realization of vehicle-to-everything (V2X) has been discussed, and the development of appropriate specifications is in progress. Herein, the V2X is a portion of an intelligent transport system. (ITS) and is a generic term for vesicle-to-vehicle (V2V) denoting a form of communication performed between vehicles, vehicle-to-infrastructure (V2I) denoting a form of communication performed between a vehicle and a road-side unit (RSU) installed in a roadside, vehicle-to-nomadic apparatus (V2N) denoting a form of communication performed between a vehicle and a mobile terminal, and vehicle-to-pedestrian (V2P) denoting a form of communication performed between a vehicle and a mobile terminal of a pedestrian.

### CITATION LIST

### Non-Patent Document

Non-patent Document 1: 3GPP TS 36.213 V14.3.0 (2017-06)

### SUMMARY OF THE INVENTION

### Problem to be Solved by the Invention

Inter-terminal direct communication channels to be used in inter-terminal direct communication (sidelink technologies) include the following channels.

A channel for transmitting control information such as sidelink control information (SCI) is referred to as a physical sidelink control channel (PSCCH), and a channel for transmitting data is referred to as a physical sidelink shared channel (PSSCH). In addition, in the V2X of NR, supporting a hybrid automatic repeat request (HARQ) for the PSCCH and the PSCCH is defined, and inter terminal direct communication feedback control information (sidelink feedback control information (SFCI)) including an HARQ-ACK is defined. The SFCI is transmitted on the inter-terminal direct communication feedback channel (physical sidelink feedback channel (PSFCH)).

As one of the sidelink transmission modes of the NR-V2X, it has been proposed that, in a user equipment group (UE group) including header user equipment (header-UE) and member user equipments (member-UEs), the header user equipment performs scheduling on the member user equipments. The transmission mode may be referred to as a sidelink transmission mode 2-d or may be referred to as a different name. In addition, the header user equipment may be referred to as scheduling user equipment, and the member user equipment may be referred to as non-leader user equipment or non-scheduling user equipment.

As an architecture for implementing the sidelink transmission mode 2-d, it has been proposed that, after the determination of the header user equipment, the user equipment group is formed by associating the member user equipments with the header user equipment.

However, the procedure of radio layer in the formation of the user equipment group has not been clearly defined.

The invention has been made in view of the above problems, and an object thereof is to provide a technique for defining a procedure of radio layers in the formation of a user equipment group in inter-terminal direct communication. In addition, the invention is not limited to the inter-terminal communication in the V2X, but the invention may be applied to any terminal.

### Means for Solving Problem

According to the technology of the disclosure, there is provided user equipment including: a transmitting unit configured to transmit a preamble to another user equipment; and a receiving unit configured to receive a response to the preamble from the another user equipment.

### Effect of the Invention

According to the technology of the disclosure, provided is a technique for defining a procedure of radio layers in the formation of a user equipment group in inter-terminal direct communication.

### BRIEF DESCRIPTION OF DRAWINGS

FIG. 1 is a diagram illustrating four types of sidelink. transmission mode in NR-V2X;

FIG. 2 is a diagram illustrating a user equipment group;

FIG. 3 is a diagram illustrating the radio access procedure in LTE/NR Uu;

FIG. 4 is a diagram illustrating the radio access procedure according to the embodiment;

FIG. 5 is a diagram illustrating preambles orthogonal to each other among user equipment groups;

FIG. 6 is a diagram illustrating an example of the functional configuration of a base station apparatus 10 according to the embodiment;

FIG. 7 is a diagram illustrating an example of the functional configuration of a user equipment 20 according to the embodiment; and

FIG. 8 is a diagram illustrating an example of the hardware configuration of the base station apparatus 10 and the user equipment 20 according to the embodiment.

### MODE(S) FOR CARRYING OUE THE INVENTION

Hereinafter, embodiments (the present embodiments) of the in will be described with reference to the drawings. In addition, the embodiments described below are only intended to be examples, and the embodiments to which the invention is applied are not limited to the following embodiments.

(Sidelink Transmission Mode)

Sidelink transmission modes of NR-V2X will be described.

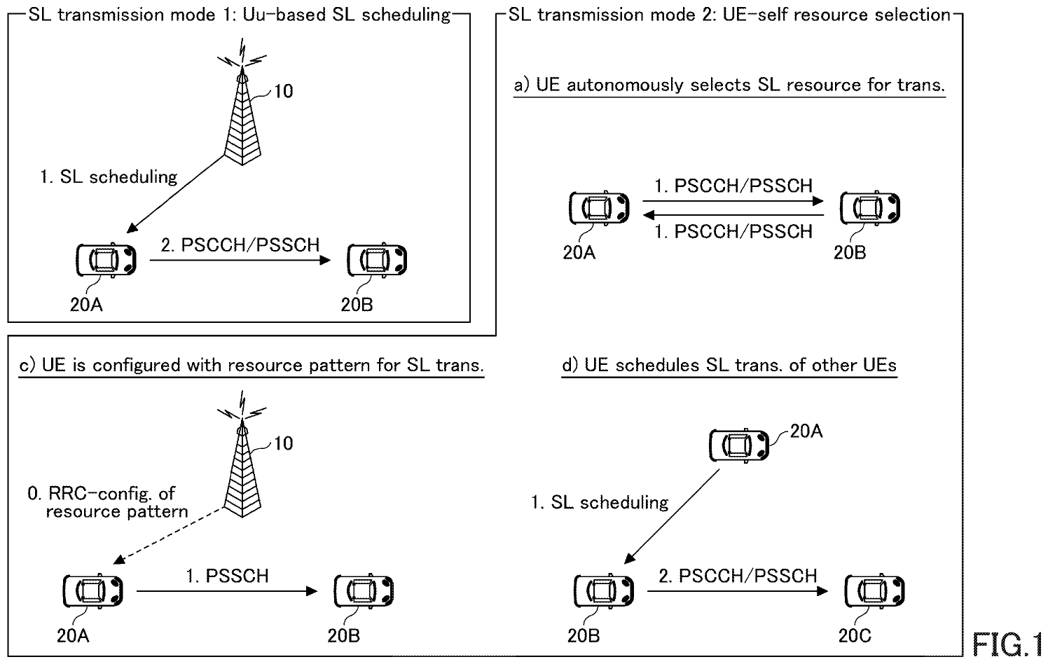

FIG. 1 is a diagram illustrating four types of the sidelink transmission modes of the NR-V2X.

In a sidelink transmission mode 1 of the NR-V2X, user equipment 20A transmits PSCCH/PSSCH to user equipment 20B based on St scheduling by a base station apparatus 10.

In a sidelink transmission mode 2 of the NR-V2X, transmission of PSCCH/PSSCH is performed based on resource selection of the user equipment itself. The sidelink transmission mode 2 of the NR-V2X may be further subdivided, in a sidelink transmission mode 2-a of the NR-V2X. In a sidelink transmission mode 2-a , the user equipment 20A transmits the PSCCH/PSSCH to the user equipment 20B based on the resource selection of the user equipment 20A itself, and the user equipment 20B transmits the PSCCH/PSSCH to the user equipment A based on the resource selection of the user equipment 20B itself. sidelink transmission mode 2-c of the NR-V2X, according to RRC-config of a resource pattern indicated by the base station apparatus 10 or determined. by specifications, the user equipment 2071 transmits the PSSCH to the user equipment 20B.

In a sidelink transmission mode 2-d of the NR-V2X, the user equipment 20A performs scheduling for transmission of the user equipment 20B by transmitting the SL scheduling to the user equipment 20B, and the user equipment 20B transmits the PSCCH/PSSCH to the user equipment 20A based on the scheduling.

(User Equipment Group)

A user equipment group (UE group) will be described.

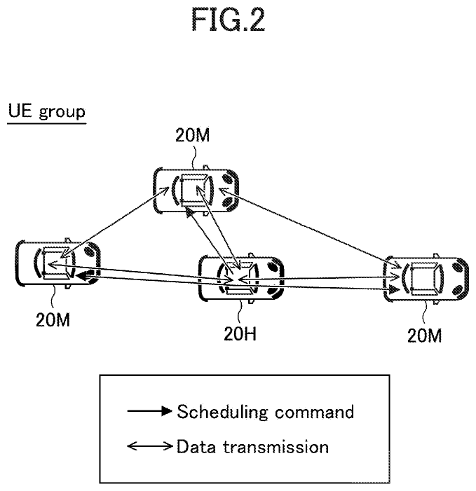

FIG. 2 is a diagram illustrating the user equipment group. As an architecture for realizing the sidelink transmission mode 2-d , resource allocation (UE-scheduling based resource allocation) based on user equipment scheduling as described below has been proposed.

1. Determine header user equipment 20H.

2. Associate member user equipment 20M with the header user equipment 20H (that is, form a user equipment group).

3. Determine resource(s)/resource set (S) used for each user equipment group.

4. The Header user equipment 20H performs scheduling of the resource in the resource set allocated to the user equipment group for the member user equipment 20M.

In the above-mentioned “3.”, by allocating the resource sets orthogonal to each other to a plurality of the user equipment groups adjacent to each other, it is possible to reduce resource interference among the user equipment groups.

In the above-mentioned “4.”, it is assumed that each header user equipment 20H performs independent scheduling. In addition, the algorithm of the scheduler depends on the implementation of the user equipment. During the scheduling, a procedure is assumed including: requesting sidelink scheduling; and indicating a scheduled resource.

(Radio Access Procedure in LTE/NR Uu)

Before describing a radio access procedure in the present embodiment, a radio access procedure in an LTE/NR Uu will be described.

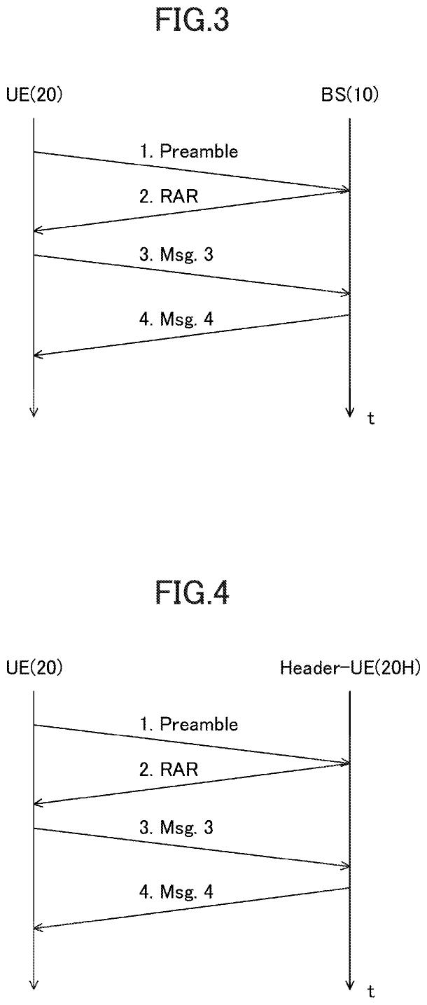

FIG. 3 is a diagram illustrating the radio access procedure in the LTE/NR Uu.

As illustrated in FIG. 3, in the radio access procedure in the LTE/NR Uu, the following operations are performed between the user equipment 20 and the base station apparatus 10.

0. A synchronization. signal block (SSB) (synchronization signal (SS)/physical broadcast channel (PBCH) is periodically transmitted. from the base station apparatus 10 (not illustrated).

1. A preamble is transmitted from the user equipment 20 to the base station apparatus 10.

2. A radio access response (RAR) is transmitted on a PDCCH from the base station apparatus 10 to the user equipment 20.

3. A message 3 (Msg.3) is transmitted on a physical uplink shared channel (PUSCH) scheduled by a UL grant included in the RAR from the user equipment 20 to the base station apparatus 10.

4. A message 4 (Msg.4) is transmitted on a physical downlink shared channel (PDSCH) from the base station apparatus 10 to the user equipment 20.

In the RAR transmitted on the PDCCH in the above-mentioned 2, a DCI is scrambled by a random access-radio network temporary identifier (RA-RNTI). In the RAR, downlink allocation is transmitted on the PDCCH, and higher layer signaling is transmitted on the corresponding PDSCH. The higher layer signaling includes RAR Us grant scheduling an uplink data channel (PUSCH).

(Radio Access Procedure in Embodiment)

The radio access procedure in the present embodiment will be described.

FIG. 4 is a diagram illustrating the radio access procedure in the present embodiment.

As illustrated in FIG. 4, in the radio access procedure in the present embodiment, the following operations are performed between the user equipment 20 and the header user equipment 20H.

1. A signal corresponding to the preamble in the radio access procedure in the LTE/NR Uu is transmitted from the user equipment 20 to the header user equipment 20H.

2. A signal corresponding to the RAR in the radio access procedure in the LTE/NR Uu is transmitted from the header user equipment 20H to the user equipment 20.

3. A signal corresponding to the message 3 (Msg.3) in the radio access procedure in the LTE/NR Uu is transmitted from the user equipment 20 to the header user equipment 20H.

4. A signal corresponding to the message 4 (Msg.4) in the radio access procedure in the LTE/NR Uu is transmitted from the header user equipment to the user equipment.

In addition, the above-mentioned message 3 may be replaced in reading with, for example, the PSSCH scheduled by the PSCCH scrambled by a specific RNTI (for example, SL-RARV-RNTI) or the PSSCH scheduled. by a signal corresponding to the RAR and may be a different name. In. addition, the message 4 may be replaced in reading with, for example, the PSCCH scrambled by a specific RNTI and/or the PSSCH allocated by the PSCCH and may be a different name.

Hereinafter, each of the operations 1 to 4 will be described. in detail.

(Preamble)

The user equipment 20 requiring association with the predetermined. header user equipment 20H transmits random access signaling (for example, a preamble/sequence).

The user equipment 20 may autonomously select a predetermined preamble/sequence from a plurality of the preamble/sequences that can be associated with the header user equipment 20H. The predetermined preamble/sequence may be an identifier (for example, a UE ID/RNTI, a service set identifier (SSID), a resource set ID, a user equipment group/cluster ID (UE-group/cluster ID), virtual ID (for example, an ID having the same function as a cell ID), or a portion thereof) of the header user equipment 20H. Herein, it is possible to define one set of virtual IDs, a certain virtual ID may be set (in advance) by the header user equipment 20H, and a certain virtual ID may be selected by the header user equipment 20H. Similarly to the cell ID, the virtual ID may be informed by the header user equipment 20H, for example, via a physical sidelink broadcast channel (PSBCH). In this manner, the orthogonality of the preambles of other user equipment groups can be realized.

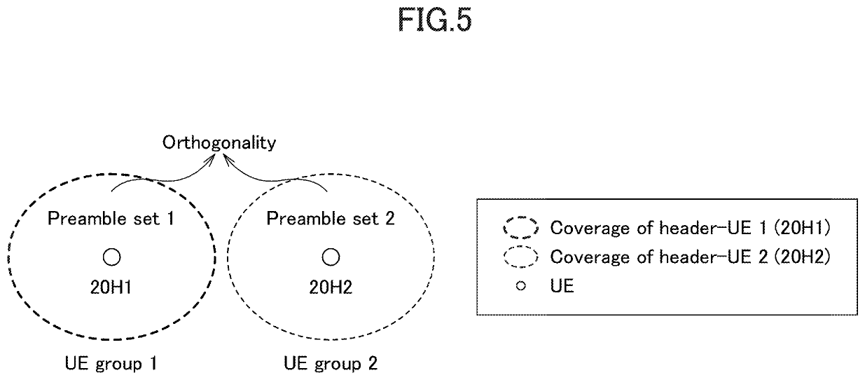

FIG. 5 is a diagram illustrating the preambles orthogonal between the user equipment groups. As illustrated in FIG. 5, in the user equipment group 1 of the header user equipment (20H1), a preamble set 1 is used, and in the user equipment qr up 2 of the header user equipment 2 (20H2), a preamble set 2 is used, so that the orthogonality is realized.

As an alternative to the preamble/sequence used, the user equipment 20 may select information, represented by the sidelink-synchronization signal block (S-SSB) from the header user equipment 20H, for example, a sequence and/or a preamble/sequence using time frequency resource.

As a physical channel for transmitting the preamble, a preamble transmission channel for sidelink, that is, a sidelink PHY random access channel (SL-PRACH) as a dedicated channel corresponding to the physical random access channel (PRACH) in the radio access procedure in the LTE/NR Uu may be set (in advance).

As a trigger condition A of the preamble transmission by the user equipment 20: (1) in a case where the user equipment 20 is not associated with any of the header user equipments 20H; (2) in a case where the user equipment 20 changes the associated. header user equipment 20H; (3) in a case where the user equipment 20 can be associated with a plurality of the header user equipments 20H and the number of header user equipments 20H that are already associated does not reach the maximum. number of the associated header user equipments 20H; and the like, are considered.

Only one of (1), (2), and (3) of the condition A may be satisfied, or, a plurality thereof may be satisfied.

As a trigger condition B of the preamble transmission by the user equipment 20: (1) in a case where the user equipment 20 receives the S-SSB from the associated header user equipment 20H; (2) in a case where the power measurement obtained from the S-SSB or another reference signal (RS) from the associated header user equipment 20H exceeds a threshold value that is set (in advance); and the like, are considered.

Only one of (1) and (2) of the condition B may be satisfied, or both thereof may be satisfied.

In a case where one or both of the trigger conditions A and B of the preamble transmission by the user equipment 20 is satisfied, the user equipment may transmit the preamble on the corresponding SL-PRACH resource.

In addition, the S-SSB transmitted from. the header user equipment 20H may include the information indicating that the header user equipment 20H is able to become the header user equipment 20H.

With respect to the reception of the preamble transmitted from, the user equipment 20, it may be defined or set (in advance) that the header user equipment 20H monitors the SL-PRACH resource.

(RAR)

The header user equipment 20H transmits the RAR signaling to the user equipment 20 that has detected the preamble.

The RAR signaling may include at least the resource allocation (resource grant). of the resource for example, PSCCH/PSSCH resource) corresponding to the resource for the transmission of the message 3 of the LTE/NR Uu.

In addition, a temporary sidelink RNTI (SL-RNTI) allocated by the header user equipment 20H may also be transmitted by the RAR signaling. The SL-RNTI can be used at least to scramble the messages corresponding to the message 3 and the message 4 of the LTE/NR Uu. In addition, the resource allocation (resource grant) of the resource corresponding to the resource for the transmission of the message 3 of the LTE/NR Uu may be included in the higher layer signaling.

The physical channel for transmitting the RAR may be at least one of the PSCCH and the PSSCH allocated by the PSCCH.

The PSCCH and the PSSCH allocated by the PSCCH may be scrambled by separate RNTIs (for example, RNTIs based on the time-frequency resource location of the detected preamble or the ID of the sequence). In addition, the PSCCH and the PSSCH allocated by the PSCCH may include explicitly the time-frequency resource location of the detected preamble or the ID of the sequence. By using the PSCCH and the PSSCH allocated by the PSCCH as a physical channel for transmitting the RAR, the user equipment 20, which is the member user equipment 20M, can determine that the RAR is transmitted to the user equipment 20.

The RAR may be transmitted, for example, between specified time intervals after the preamble detection or time intervals set (in advance).

With respect to the reception of the RAR, it may be defined or set (in advance) that the user equipment 20 which has transmitted the preamble monitors the RAR signaling between the time intervals defined or set (in advance) for the transmission of the RAR. In addition, in a case where the RAR is not received between the time intervals, the preamble may be retransmitted.

(Message 3 and Message 4)

The user equipment 20 transmitting the preamble and decoding the corresponding RAR signaling feeds back at least the user equipment ID (UE ID) on the resource corresponding to the allocated message 3. The information for the PC 5-RRC connection/resume between the header user equipment 20H and member user equipment 20M may be carried by the message corresponding to the message 3.

After decoding the message corresponding to the message 3, the header user equipment 20H transmits the message corresponding to the message 4, so that the random access/association collision is solved.

The transmission of the message corresponding to the message 4 may be performed between the time intervals that are defined or set (in advance), for example, after the reception of the message corresponding to the message 3.

The user equipment 20 that has transmitted the message corresponding to the message 3 may monitor the message corresponding to the message 4 between the time intervals that are defined or set (in advance).

The message corresponding to the message 4 may include at least the user equipment ID (UE ID) associated with the header user equipment 20H.

The sidelink-scheduling request (SL-SR) resource for the associated user equipment 20 may be carried by the message corresponding to the message 4.

The information for the PC 5-RRC connection/resume between. the header user equipment 20H and member user equipment 20M may be carried. by the message corresponding to message 4.

The message corresponding to the message 4 may be transmitted on the PSCCH/PSSCH. The resource for the message corresponding to the message 4 may be scheduled by the header user equipment 20H, and may be indicated (for example, by the indication via the PSCCH).

The signaling to indicate the resource for the message corresponding to the message 4 may reflect at least the destination of the signaling (for example, may be scrambled based on the destination ID, or the destination ID may be explicitly included in the signaling).

According to the above-described procedure, a technique for defining a procedure of the radio layer associating the user equipment 20 with the header user equipment 20H is provided.

(Apparatus Configuration)

Next, a functional configuration example of the base station apparatus 10 and the user equipment 20 executing the processes and the operations described above. The base station apparatus 10 and the user equipment 20 have the functions for carrying out the embodiments described above. However, each of the base station apparatus 10 and the user equipment 20 may have only a portion. of the functions in the embodiment.

<Base Station Apparatus 10>

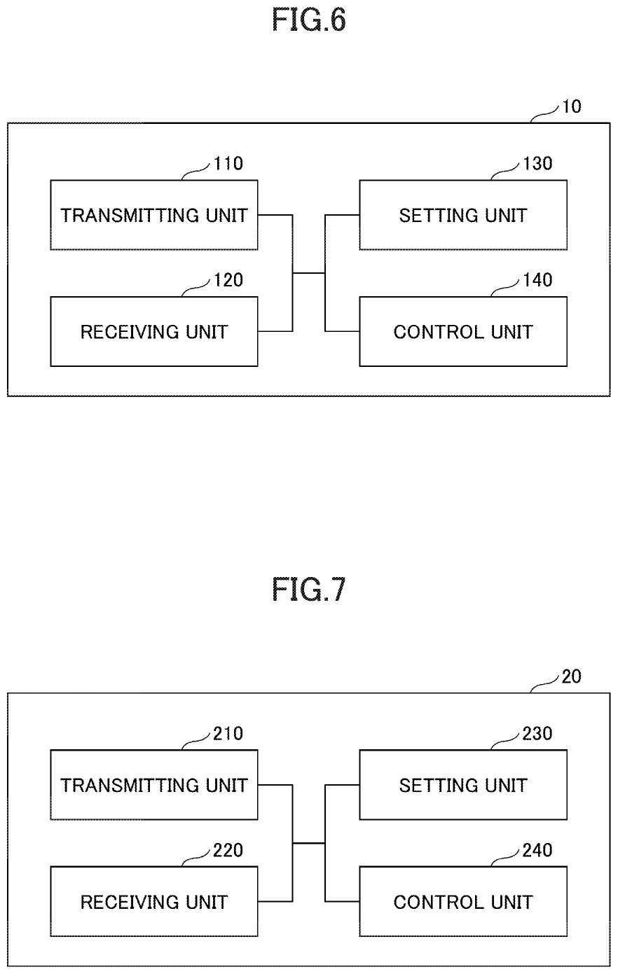

FIG. 6 is a diagram illustrating an example of a functional configuration of the base station apparatus 10, As illustrated in FIG. 6, the base station apparatus 10 includes a transmitting unit 110, a receiving unit 120, a setting unit 130, and a control unit 140. The functional configuration illustrated in FIG. 6 is only an example. As long as a component can perform operations according to the embodiment of the invention, any name of the functional configuration and the functional unit may be employed.

The transmitting unit 110 includes a function of generating a signal to be transmitted to the user equipment 20 and transmitting the signal in a wireless manner. In addition, the transmitting unit 110 transmits the information of the SL scheduling or the like to the user equipment 20. The receiving unit 120 has a function of receiving various types of signals transmitted. from the user equipment 20 and acquiring the information of, for example, the higher layer from the received signal.

The setting unit 130 stores the setting information that is set in advance and various pieces of the setting information to be transmitted to the user equipment 20 in the storage device and reads the setting information from the storage device as required The content of the setting information is, for example, information or the like related to the setting of the V2X.

As described. in the example, the control unit 140 performs processing according to the setting for performing V2X by the user equipment 20. In addition, a functional unit related. to the signal transmission in the control unit 140 may be included in the transmitting unit 110, and a functional unit related to the signal reception in the control unit 140 may be included. in the receiving unit 120.

<User Equipment 20>

FIG. 7 is a diagram illustrating an example of a functional configuration of the user equipment 20. As illustrated in FIG. 7, the user equipment 20 includes a transmitting unit 210, a receiving unit 220, a setting unit 230, and a control unit 240. The functional configuration illustrated in FIG. 7 is only an example. Any functional division may be applied and any functional unit name may be applied as long as the operation according to the embodiment of the invention can be performed.

The transmitting unit 210 generates a transmission signal from the transmission data and transmits the transmission signal in a wireless manner. The receiving unit 220 receives various signals in a wireless manner and acquires a signal of a higher layer from the received signal of the physical layer. The receiving unit 220 has a function of receiving the SL. scheduling transmitted from the base station apparatus 10. The receiving unit 220 is a receiving unit 220 of the header user equipment 20H and has a function of receiving the preamble and the message corresponding to the message 3 transmitted from another user equipment. The transmitting unit 210 is a transmitting unit 210 of the header user equipment 20H and has a function of transmitting the RAR and the message corresponding to the message 4 to the another user equipment 20. The receiving unit 220 is a receiving unit 220 of the member user equipment 20M and has a function of receiving the RAR and the message corresponding to the message 4 transmitted from the another user equipment. The transmitting unit 210 is a transmitting unit 210 of the member user equipment 20M and has a function of transmitting the preamble and the message corresponding to the message 3 to the another user equipment 20.

The setting unit 230 stores various pieces of the setting information received from the base station apparatus 10 or the user equipment 20 by the receiving unit 220 in the storage device and reads the setting information from the storage device as required. In addition, the setting unit 20 also stores the setting information set in advance. The content of the setting information is, for example, information or the like related to the V2X and HARQ processes.

As described in Example, the control unit 240 controls the D2D communication to be performed with another user equipment 20. In addition, the control unit 240 executes the radio access procedure with the another user equipment 20. A. functional unit related to the signal transmission in the control unit 240 may be included in the transmitting unit 210, and a functional unit related to the signal reception in the control unit 240 may be included in the receiving unit 220.

(Hardware Configuration)

The functional configuration diagrams (FIGS. 6 and 7) used in the description of the embodiments of the invention described above illustrates blocks of functional unit. These functional blocks (components) are realized by any combinations of hardware and software. In addition, the means for realizing the functional blocks are not particularly limited. That is, each functional block may be realized by a single apparatus obtained by physically and/or logically coupling a plurality of elements or may be realized by using a plurality of apparatuses obtained. by connecting directly and/or indirectly (for example, in wired and/or wireless manners) two or more apparatuses physically and/or logically separated.

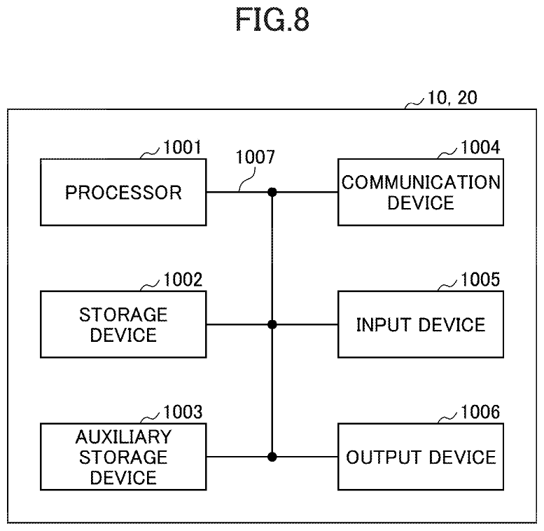

In addition, for example, both the base station apparatus 10 and the user equipment 20 according to the embodiment of the invention may function as a computer for performing processing according to the embodiment of the invention. FIG. 8 is a diagram illustrating an example of a hardware configuration of the radio communication device which is the base station apparatus 10 or the user equipment 20 according to the embodiment of the invention. Each of the base station apparatus 10 and the user equipment 20 described above may be physically configured as a computer system including a processor 1001, a storage device 1002, an auxiliary storage device 1003, a communication device 1004, an input device 1005, output device 1006, a bus 1007, and the like.

In addition, in the following description, the term “apparatus” can be replaced with circuit, device, unit, or the like in reading. The hardware configuration of the base station apparatus 10 and the user equipment 20 may be configured so that each apparatus includes one or a plurality of devices represented by 1001 to 1006 illustrated in the figure and may be configured so as not to include a portion of the devices.

Each function in the base station apparatus 10 and the user equipment 20 is realized by reading predetermined software (program) on hardware of the processor 1001, the storage device 1002, and the like allowing the processor 1001 to perform calculating, and controlling communication by the communication device 1004, reading and/or writing of data in the storage device 1002 and the auxiliary storage device 1003.

The processor 1001 controls the entire computer by operating, for example, an operating system. The processor 1001 may be configured by a central processing unit (CPU) including an interface with peripheral devices, a control device, an arithmetic device, a register, and the like.

In addition, the processor 1001 reads a program (program code), a software module, or a data from the auxiliary storage device 1003 and/or the communication device 1004 into the storage device 1002 and performs various processes in accordance with the program or the like. As the program, a program that causes a computer to execute at least a portion of the operations described in the above embodiment is used. For example, the transmitting unit 110, the receiving unit 120, setting unit 130, and the control unit 140 of the base station apparatus 10 illustrated in FIG. 6 may be realized by a control program that is stored in the storage device 1002 and runs on. the processor 1001. In addition, for example, the transmitting unit 210, the receiving unit 220, the setting unit 230, and the control unit 240 of the user equipment 20 illustrated in FIG. 7 may be realized by a control program that is stored in the storage device 1002 and runs on the processor 1001. Various types of processing described above have been described. to be executed by one processor 1001, but various types of processing may be executed simultaneously or sequentially by two or more processors 1001. The processor 1001 may be implemented by one or more chips. In addition, the program may be transmitted from the network via a telecommunication line.

The storage device 1002 is a computer-readable recording medium and may be configured with at least one of, for example, a read only memory (ROM), an erasable programmable ROM (EPROM), an electrically erasable programmable ROM (EEPROM), and a random access memory (RAM). The storage device 1002 may be referred to as a register, a cache, a main memory (main storage device), or the like. The storage device 1002 can store a program (program codes), a software module, or the like which can be executed for performing the communication method according to the embodiment of the invention.

The auxiliary storage device 1003 is a computer. readable recording medium and may be configured. with at least one of, for example, an optical disk of a compact disk RPM (CD-ROM) or the like, a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and the like. The auxiliary storage device 1003 may be referred to as an auxiliary storage device, The above-mentioned storage medium may be, for example, a database, a server, or other suitable media including the storage device 1002 and/or the auxiliary storage device 1003.

The communication device 1004 is hardware (transmission/reception device) for performing communication between computers via a wired network and a wireless network and is also referred to as, for example, a network device, a network controller, a network card, a communication module, or the like. For example, the transmitting unit 110 and the receiving unit 120 of the base station apparatus 10 may be realized by the communication device 1004. In addition, the transmitting unit 210 and the receiving unit 220 of the user equipment 20 may be realized by the communication device 1004.

The input device 1005 is an input device (for example, a keyboard, a mouse, a microphone, switches, buttons, sensors, or the like) that receives an external input. The output device 1006 is an output device (for example, a display, a speaker, an LED lamp, or the like) that performs external output. In addition, the input device 1005 and output device 1006 may have a configuration (for example, a touch panel) in which the input device 1005 and output device 1005 are integrated.

In addition, each device such as the processor 1001 and the storage device 1002 are connected. by a bus 1007 for communicating information. The bus 1007 may be configured by using a single bus or may be configured by using a different bus for every device.

In addition, each of the base station apparatus 10 and the user equipment 20 may be configured to include hardware of a microprocessor, a digital signal processor (DSP), an application specific integrated circuit (ASIC), a programmable logic device (PLD), a (field programmable gate array (FPGA), or the like, and a portion of or all of the functional blocks may be realized by the hardware. For example, the processor 1001 may be implemented by using at least one of these hardware processors.

(Summary of Embodiment)

As described above, the embodiment of the invention provides a user equipment; including a transmitting unit configured to transmit a preamble to another user equipment; and a receiving unit configured to receive a response to the preamble from the another user equipment.

In addition, the embodiment of the invention provides user equipment including: a receiving unit configured to receive a preamble from another user equipment; and a transmitting unit configured to transmit a response to the preamble to the another user equipment.

By the above described configurations, a technique for defining a procedure of radio layers in the formation of a user equipment group in inter-terminal direct communication is provided.

(Supplementary Embodiment)

Heretofore, although the embodiments of the invention have been described, the disclosed invention is not limited to the embodiments, and various variations that modified examples, changed examples, alternative examples, or the like will be understood by those skilled in the art. Although the invention has been described with reference to specific numerical examples in order to facilitate the understanding of the invention, these values are simply illustrative, but any suitable values may be used unless otherwise noted. The distinction of items in the above description is not essential to the invention, matters described in two or more items may be used in combination as needed, and matters described in a certain item may be applied to matters described in another (unless inconsistent). Boundaries of the functional units or the processing units in the functional block diagram do not necessarily correspond to the boundaries of the physical components. The operations of a plurality of functional units may be performed physically by a single component, or the operations of a single functional unit may be physically performed by a plurality of components. In the processing procedure described in the embodiments, the order of the processing may be changed unless inconsistent. For the convenience of description of the processing, although the base station apparatus 10 and the user equipment 20 has been described by using functional block diagrams, but these apparatuses may be realized in hardware, software, or a combination thereof. Each of the software operated by a processor included in the user equipment 20 according to the embodiment of the invention and the software operated by a processor included in the base station apparatus 10 according to the embodiment of the invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

In addition, the information indication is not limited to the aspect/embodiment described in this specification, but the information indication may be performed by using other methods. For example, the information indication may be performed by using physical layer signaling (for example, downlink control information. (DCI) or uplink control information (UC)), higher layer signaling (for example, radio resource control (RRC) signaling or medium access control (MAC) signaling, broadcast information master information block (MIB) or system information block (SIB)), other signals, or a combination thereof. I addition, the RRC signaling may be referred to as an RRC message, and the RRC message may be, for example, an RRC connection setup message, an RRC connection reconfiguration message, or the like.

Each aspect/embodiment described in this specification may be applied to at least one of long term evolution (LTE), LTE-advanced (LTE-A), SUPER 3G, IMT-advanced, 4th generation mobile communication system (4G), 5th generation mobile communication system (5G), future radio access (FRA), new radio (NR), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using other suitable system, and/or a next-generation system extended based on the above-mentioned ones.

In the procedure, sequence, flowchart, and the like in each aspect/embodiment described in this specification, the order may be changed unless inconsistent. For example, for the method described in this specification, elements of the various steps are presented by using an exemplary order, and the invention is not limited to the specific order presented.

In this specification, in some cases, a specific operation described as being performed by the base station apparatus 10 may also be performed by the upper node. In a network configured with one network node or a plurality of network nodes included in the base station apparatus 10, it is apparent that various operations performed for communication with the user equipment 20 may be performed by at least one of the base station apparatus 10 and network nodes (for example, MME, S-GW or the like is considered, but the network nodes are not limited thereto) other than the base station apparatus 10. A case where there is one network node other than the base station apparatus 10 is exemplified in the above description, but the one network node other than the base station apparatus 10 may be a combination. of a plurality of other network nodes (for example, MME and S-GW).

Each aspect/embodiment described in this specification may be used alone, may be used in combination, or may be used. with being switched in accordance with the execution.

In some cases, the user equipment 20 may also be referred by those skilled in the art as a subscriber station, a mobile unit, a subscriber unit, a radio unit, a remote unit, a mobile device, radio device, radio communications device, a remote device, a mobile subscriber station, an access terminal, a mobile terminal, a radio terminal, a remote terminal, a handset, a user agent, a mobile client, a client, or other suitable terms.

In some cases, the base station apparatus 10 may also be referred by those skilled in the art as a NodeB (NB), an evolved NodeB (eNB), a gNB, a base station, or other suitable terms.

In some cases, the terms “determining” and “deciding (determining) used in this specification may include various types of operations. The ” determining” and “deciding” may include, for example, judging, calculating, computing, processing, deriving, investigating, searching (looking up, searching, inquiry) (for example, looking up in a table, searching in a database or another data structure), and checking (ascertaining) that have been considered. to be “determining” or “deciding”. In addition, the “determining” and “deciding” may include receiving (for example, receiving information.), transmitting (for example, transmitting information.), inputting, outputting, and accessing (for example, accessing data in a memory) that have been considered to be “determining” or “deciding”. In addition, the “determining” and “deciding” may include resolving, selecting, choosing, establishing, and comparing that have been considered. to be “determining” or “deciding”. In other words, the “determining” and “deciding” may include some operation that has been considered to be “determining” or “deciding”.

The phrase “based on” as used in this specification does not denote “based on only” unless specifically stated otherwise. In other words, the phrase “based on” denotes both “based on only” and “based on at least”.

As long as the terms “include”, “including”, and variations thereof are used in this specification or the claims, these terms are intended to be construed as inclusive similarly to the term “comprising”. Furthermore, the term “or” as used in the description or the claims is intended not to be construed as “exclusive or”.

In the entire disclosure, for example, in a case where articles “a”, “an”, and “the” in English are added in the translation, nouns following these articles include nouns in a plural form unless it is stated that this is not clarified from the context.

In addition, in the embodiments of the invention, a resource request is an example of a scheduling request, the resource grant is an example of a scheduling grant, the scheduling user equipment is ah example of the header user equipment.

Heretofore, although. the invention. has been described in detail, it is obvious to those skilled in the art that the invention is not limited to the embodiments described in this specification. The invention can be carried out as modified and changed modes without departing from the scope of the invention defined by the description of the claims. Accordingly, the description of this specification is intended to make exemplary description, hut not intended to have any restrictive meaning with respect to the invention.

### EXPLANATIONS OF LETTERS OR NUMERALS

10 BASE STATION APRARATUS

110 TRANSMITTING UNIT

120 RECEIVING UNIT

130 SETTING UNIT

140 CONTROL UNIT

20 USER EQUIPMENT

210 TRANSMITTING UNIT

220 RECEIVING UNIT

230 SETTING UNIT

240 CONTROL UNIT

1001 PROCESSOR.

1002 STORAGE DEVICE

1003 AUXILIARY STORAGE DEVICE

1004 COMMUNICATION DEVICE

1005 INPUE DEVICE

1006 OUEPUE DEVICE

1. A user equipment comprising:
a transmitting unit configured to transmit a preamble to another user equipment; and
a receiving unit configured to receive a response to the preamble from the another user equipment.

2. The user equipment according to claim 1, wherein the transmitting unit transmits a message containing an identifier of the user equipment to the another user equipment in response to receiving the response to the preamble.

3. The user equipment according to claim 2, wherein the receiving unit receives a message from the another user equipment, the message containing information associating the user equipment with the another user equipment.

4. A user equipment comprising:
a receiving unit configured to receive a preamble from another user equipment; and
a transmitting unit configured to transmit a response to the preamble to the another user equipment.

5. The user equipment according to claim. 4, wherein the receiving unit receives a message containing an identifier of the another user equipment from the another user equipment in response to transmitting the response to the preamble.

6. The user equipment according to claim 5, wherein the transmitting unit transmits a message to the another user equipment, the message containing information associating the another user equipment with the user equipment.
